(19) United States
(12) Patent Application Publication
(10) Pub. No.: US 2014/0335235 A1
(43) Pub. Date: Nov. 13, 2014

(54) PACKAGING MATERIALS, PACKAGES, PACKAGED FOOD PRODUCTS, AND RELATED METHODS

(71) Applicant: GENERAL MILLS, INC., Minneapolis, MN (US)

(72) Inventors: Anthony W. Swenson, Blaine, MN (US); Neil E. Zaporski, South Burlington, VT (US)

(73) Assignee: GENERAL MILLS, INC., Minneapolis, US (unknown)

(21) Appl. No.: 14/362,519

(22) PCT Filed: Dec. 6, 2012
(86) PCT No.: PCT/US2012/068101

§ 371 Date: Jun. 3, 2014

Related U.S. Application Data
(60) Provisional application No. 61/567,217, filed on Dec. 6, 2011.

(51) Int. Cl. B65D 81/34; B29C 59/16; B65D 65/40

(52) U.S. Cl. CPC B65D 81/34; B65D 65/40; B29C 59/16; B29K 2067/003
USPC 426/113; 426/394; 428/43; 83/30; 264/138; 264/400

(57) ABSTRACT

Disclosed are packaged frozen precooked dough or batter-based food products and methods of heating the food products. The packaged precooked frozen dough or batter-based food products comprises one or more frozen precooked dough or batter-based food products that are encased in a pouch for heating. The pouch is sealed with the exception of the presence of two or more vent holes that function to release air or steam that may otherwise cause the food product to become soggy when they are heated in an oven.

### BACKGROUND

The packaging industry is in continual need of improved packaging materials having new or advantageous uses, properties, or product performance features. Product packaging is no longer a mere means for containing a product during transport or sale, but can be an important feature of the product itself. The packaging can be useful for marketing and advertising, but also now for adding product use or performance features. Heatable product packaging can be used in the food industry to allow a packaged food product to be heated in the package and optionally consumed from the package. If the package contains a single serving of a food product, is easy to open, and allows for convenient use, the package is more than just a holder for the food but is a means for improving the use and enjoyment of the food product it contains. New and newly useful packaging materials are desirable for food and non-food products, especially if the packaging material provides new or advantageous functionality for a contained product.

Food packages illustrate how a packaging material or package configuration can improve the value of a packaged product. Precooked frozen food products are very desirable to consumers because precooked frozen products can be stored for long periods of time and then heated quickly in a conventional oven, convection oven, or microwave oven for consumption. The use of a package that allows in-package heating or consumption of the contained food product offers added value.

As more specific examples, packages that allow in-package heating of a contained food product, followed by a holding period useful with large-scale food processing, can be particularly desirable for certain types of precooked breakfast foods. Precooked frozen dough or batter-based food products (e.g., pancakes, French toast, fruit filled Danish, breadsticks, scones, donuts waffles, muffins, pizza rolls, and cinnamon rolls) are particularly challenging to heat from a frozen state to the optimal temperature state for consumption. The precooked frozen food products may become dry and tough if the heating conditions are too high or too long, or may become moist and soggy if the amount of moisture in the food product is too great. As an added complication, in some instances, after a frozen food product has been heated, the food product must be held in a heated state at a desirable serving temperature until the food is served. For example, when serving large groups, a large amount of food must be prepared for serving to the group at the same time. This may involve heating the frozen food product as individual servings or in batches, and then holding the heated food at a desired serving temperature until served. The holding process may cause food properties to deteriorate such that the food products are undesirable (e.g., too soggy or dry) when served.

Food products designed to be precooked and then served after heating (with optional holding time) are generally designed to be served as individual servings for consumption by one person, meaning that a package can contain an amount of precooked food product to be eaten by one consumer (e.g., a single or individual serving). The package (as opposed to the food contained in the package) can exhibit features useful for this type of preparation and serving of the food. For example, the package might contain a single serving of precooked food product, and, therefore, should be capable of being individually sold, stored, shipped, heated, held, and eaten by a consumer. The package must, therefore, be cold temperature stable, and heat stable, To be even more useful to a consumer, e.g., “user-friendly,” the package may include information on the contents (e.g., printed product labeling) and can be easily opened.

In view of the foregoing, what is desired is new packaging materials that add value to a packaged food product. As a specific example, consumers desire precooked frozen dough or batter-based food products that can be heated from a frozen state to a desired temperature (e.g., 150° F. (65.6° C.)), and may be held at the desired temperature for a holding period (e.g., 240 minutes) while maintaining a desired temperature and moisture content, optionally along with other food properties. Even more preferably, the package can be easy to open, to gain access to the precooked and heated food contents.

### SUMMARY

The invention relates to packaging materials, packages, methods of making packaging material and packages, packaged food products such as packaged frozen precooked dough or batter-based food products, and methods of heating and holding the food products.

The packaging material includes a cutline at a surface. The cutline includes partial-cut portions that extend only partially through a thickness of the heatable film, and vent hole portions that extend completely through the thickness of the heatable film. The film may be made of a useful packaging material, such as a polymer, and may be a single layer or multiple layers. Multi-layer films are preferably prepared by lamination. The cutlines may be formed by any method, including mechanical methods, laser scoring or cutting, or combinations of these. The packaging material may be useful for packaging any type of non-food product or food product, including refrigerated, frozen, or shelf-stable cooked or raw foods.

As indicated, a packaging material as described can include a “cutline” that has “scoring,” meaning a partial cut (partial in that the cut does not extend through the entire thickness of the package material) along a surface of the film. The packaging material also includes venting in the form of holes also located at the cutline that extend through the thickness of the packaging material. The scoring extends between vent holes, e.g., connects vent holes, along a length of the cutline. Alternately stated, the package includes one or more cutline along a surface, the cutline including sections of partial culling the scoring) and sections of full cutting (the vent holes). The sections of partial cutting are sections of scoring or sections of a cut of only a portion of the full thickness of the film. The sections of full cutting penetrate the entire thickness of the film, creating a vent hole or aperture in the film.

According to certain embodiments, the cutline functions as a location along which the package can be opened by pulling on one or more pieces of the package to create a separation (rip, tear, cut, etc.) along the cutline, e.g., controlled tear propagation along the cutline. The package may be openable, or may be an “easy open” package, these terms referring herein to a package that can be manually opened relatively easily along a cutline as described. The physical mode of opening may include pulling one portion (e.g., surface) of the package away from another portion (e.g., surface) of the package, at or along the cutline; i.e., before opening, surfaces of the two portions of the package border each other along a length of the cutline, and upon opening the portions separate along the cutline to produce separate portions, each having an edge that corresponds to the original cutline. Pulling the one portion will cause the portions to separate along the cutline such as by cohesive failure, tearing, or fracturing of the film at the cutline. The cutline provides a location along which a tear can easily propagate, preferably opening the package by creating a tear along the cutline, with the tear not extending beyond the cutline to a different location on a surface of the package that does not include the cutline.

While the packaging material may be useful for any food product, the described packaging materials may be particularly useful with frozen precooked dough or batter based food products. A packaged precooked frozen dough or batter-based food product as described includes one or more frozen precooked dough or batter-based food product encased in a package (e.g., pouch) for heating. The pouch is sealed with the exception of two or more vent holes that function to release air or steam that may otherwise cause the food product to become soggy when the food product is heated in an oven (e.g., microwave, convection, or conventional oven). The amount of venting in the pouch also controls the headspace atmosphere in the pouch so that the food products do not dry out excessively with extended warm hold time.

A large market for pre-prepared or pre-baked foods, e.g., breakfast foods, is for school children between Kindergarten and high school. These food products must contain food that is nutritious, tasty, efficiently prepared, and preferably easily accessed and consumed by young children. Accordingly, a packaged food product can optimally include food in a package that is easy to open.

In one aspect, the invention relates to a packaged frozen precooked dough or batter-based food product. The product includes: one or more frozen precooked dough or batter-based food product; and a heatable pouch that includes a heatable film having a thickness, the heatable pouch encasing the one or more frozen precooked dough or batter-based food products. The heatable film includes a cutline having a length and multiple partial-cut portions, each partial-cut portion having a cut that extends partially through the thickness of the heatable film. The cutline also includes multiple vent hole portions, each vent hole portion having a vent hole that extends completely through the thickness of the heatable film.

In another aspect the invention relates to a packaging material. The packaging material includes a heatable film having a width, a length, a thickness, a surface, and a surface area. The heatable film includes a cutline at the surface. The cutline includes multiple partial cut portions, each partial-cut portion including a cut that extends partially through the thickness of the heatable film. The cutline also includes multiple vent hole portions, each vent hole portion including a vent hole that extends completely through the thickness of the heatable film.

In another aspect, the invention relates to a method of preparing a heated dough or batter-based food product from a frozen packaged dough or batter-based food product. The method includes: providing a packaged frozen precooked dough or batter-based food product as described herein, including a heatable pouch encasing one or more frozen precooked dough or batter-based food product; and heating the one or more frozen precooked dough or batter-based food product in the heatable pouch.

In yet another aspect, the invention relates to a method of preparing a heatable film having vent holes and partial cuts. The method includes providing a heatable film having a width, a length, a thickness, a surface, and a surface area; and producing a cutline in the heatable film. The cutline includes a length, multiple partial-cut portions, each partial-cut portion comprising a cut that extends partially through the thickness of the heatable film. The cutline also includes multiple vent hole portions, each vent hole portion comprising a vent hole that extends completely through the thickness of the heatable film.

### BRIEF DESCRIPTION OF THE DRAWINGS

The accompanying drawings, which are incorporated in and constitute a part of this specification, illustrate several aspects of the invention and together with the description of the preferred embodiments, serve to explain the principles of the invention. A brief description of the drawings is as follows:

FIG. 1 is a perspective front view of an embodiment of packaged precooked frozen dough or batter-based food product of the invention.

FIG. 1A is perspective back view of an embodiment of packaged precooked frozen dough or batter-based food product of the invention.

FIG. 1B is a cross sectional view of the embodiment of FIG. 1 taken along line 1B-1B.

FIG. 2 is a graph displaying crust moisture as a function of vent area ratio.

FIG. 3 is a graph displaying crust moisture as a function of vent area ratio at various hold times.

FIG. 4 is a graph displaying crust moisture as a function of the number of vent holes at constant vent area ratio.

FIG. 5 is a graph displaying crust moisture percent as a function of vent area ratio for fruit filled danish for a period of 5 hours of hold time in a warming cabinet at 150° F. (65.6° C.).

FIG. 6 is a graph displaying crust moisture percent as a function of vent area ratio for French toast for a period of 5 hours of hold time in a warming cabinet at 150° F. (65.6° C.).

FIG. 7 is a graph displaying crust moisture percent as a function of vent area ratio for breadsticks for a period of 4 hours of hold time in a warming cabinet at 150° F. (65.6° C.).

FIG. 8 is a graph displaying scone crust moisture percent as a function of vent area ratio for a period of about 4 hours in a warming cabinet at 150° F. (65.6° C.).

FIG. 9 is a graph displaying pizza roll crust moisture percent as a function of vent area ratio for a period of about 4 hours in a warming cabinet at 150° F. (65.6° C.).

FIGS. 10A through 10F show examples of patterns of cutlines on an outer surface of a package.

FIGS. 11A, 11B, and 11C show detailed views of exemplary cutlines.

FIGS. 12A and 12B show embodiments of package materials and webs.

FIGS. 13A, 13B, and 13C show embodiments of a package material and a package as described.

### DETAILED DESCRIPTION

Embodiments of the invention described herein are not intended to be exhaustive or to limit the invention to the particular embodiments disclosed in the following detailed description. Rather, the embodiments are described so that others skilled in the relevant arts can understand the principles and practices of the present invention.

The invention involves a film packaging material that is formed to include a cutline, the cutline including and extending along a length, at a surface of the film. The invention also relates to packages made from the packaging material, methods of preparing the packaging material, packaged food products (e.g., precooked frozen food products) that include the packaging material, and methods of preparing or using the packaged food products.

The cutline includes two types of cuts. One cut that is part of the cutline is a full cut, or an aperture, that penetrates entirely through the thickness of the film to form an opening between the interior of the package and an exterior. The full cut functions to vent the package, as is described herein. The second type of cut is a partial cut, or a “score,” that extends between and connects full cuts, and that functions as a physical location for opening a package made of the film.

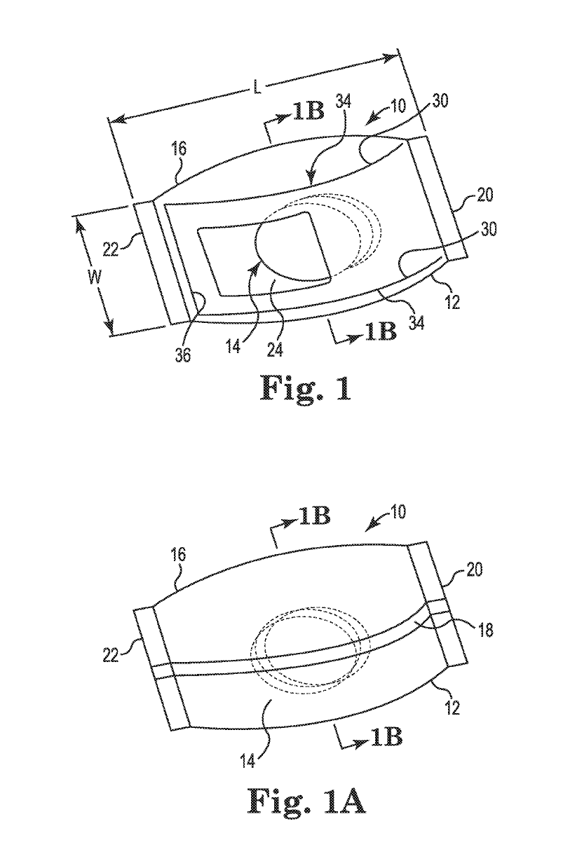

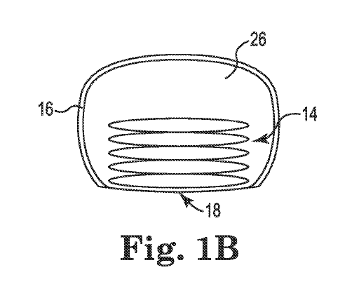

Referring now to FIG. 1, a front perspective view of an embodiment of a packaged food product according to the invention is shown. Packaged precooked frozen dough or hatter-based food product 10 includes heatable pouch 12 that encases one or more precooked frozen dough or batter based food products 14. Pouch 12 is formed from film 16 that is sealed to form longitudinal seam 18 and end seams 20 and 22 as shown in FIG. 1A. Pouch 12 also optionally includes transparent window 24 that allows the food product 14 to be viewed from the exterior of the pouch. Certain features of pouch 12, such as seams 18, 20, and 22, are similar to a pouch type package described in U.S. patent application Ser. No. 12/636,133 (“Packaged Frozen Precooked Dough or Batter-Based Food Products and Methods”), filed Dec. 11, 2009, the entirety of which is incorporated herein by reference.

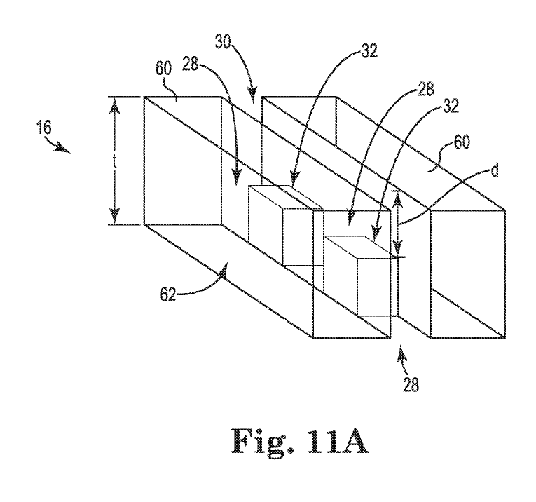

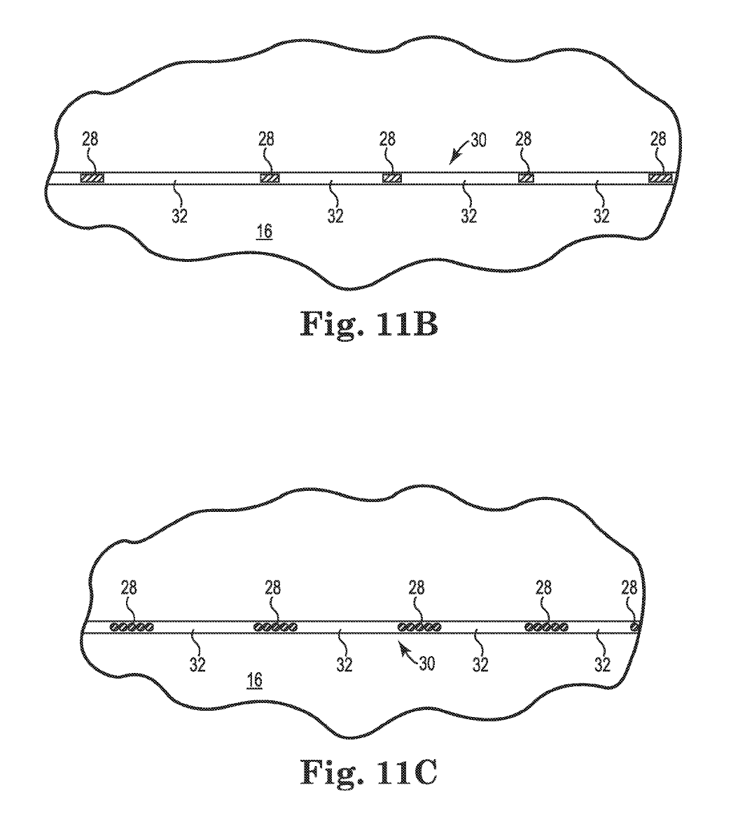

Pouch 12 includes a length (L) and a width (W). In some embodiments, the length can be considered to correspond to a “web” direction or a “machine” direction, which in the terminology of film processing is a direction in which the packaging film used to prepare package 10 travels along a machine used in the preparation or processing of the packaging film. The width can be considered to correspond to a “cross-web” direction, which in the terminology of film processing is a direction perpendicular to the direction in which the packaging film used to prepare pouch 12 travels along a machine used in the preparation or processing of the packaging film. Cutline 30 includes partial-cut portions 32 and full-cut portions (vent holes) 28 (see, e.g., FIGS. 11A, 11B, and 11C).

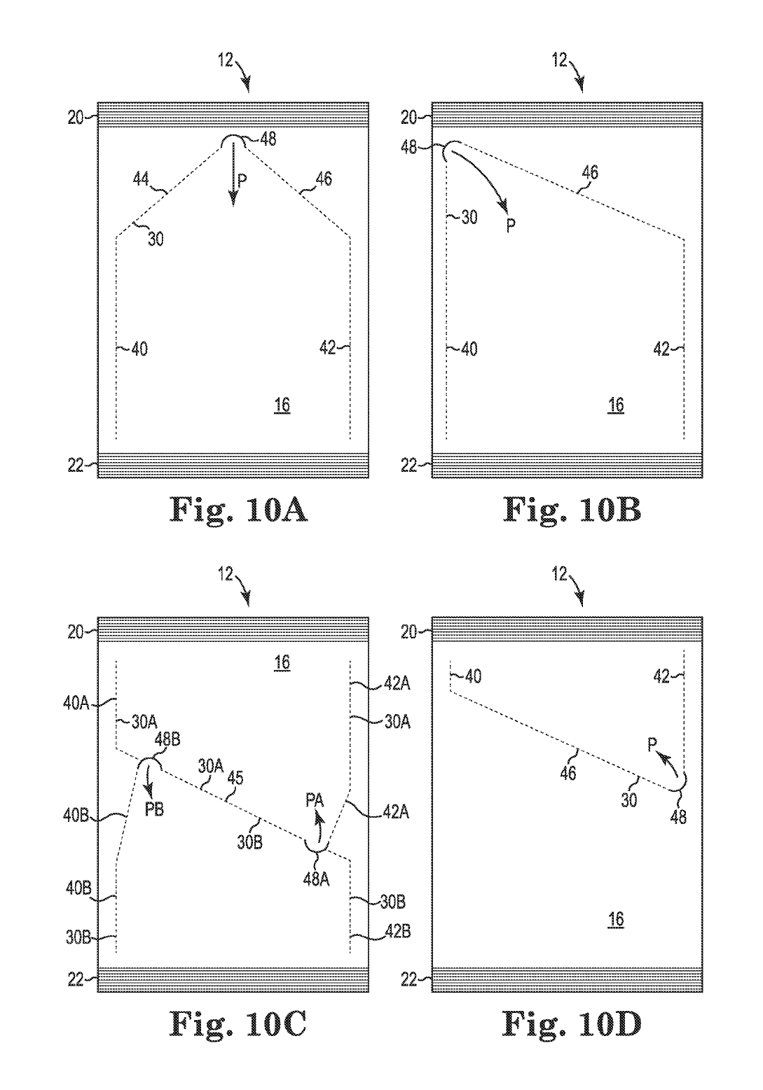

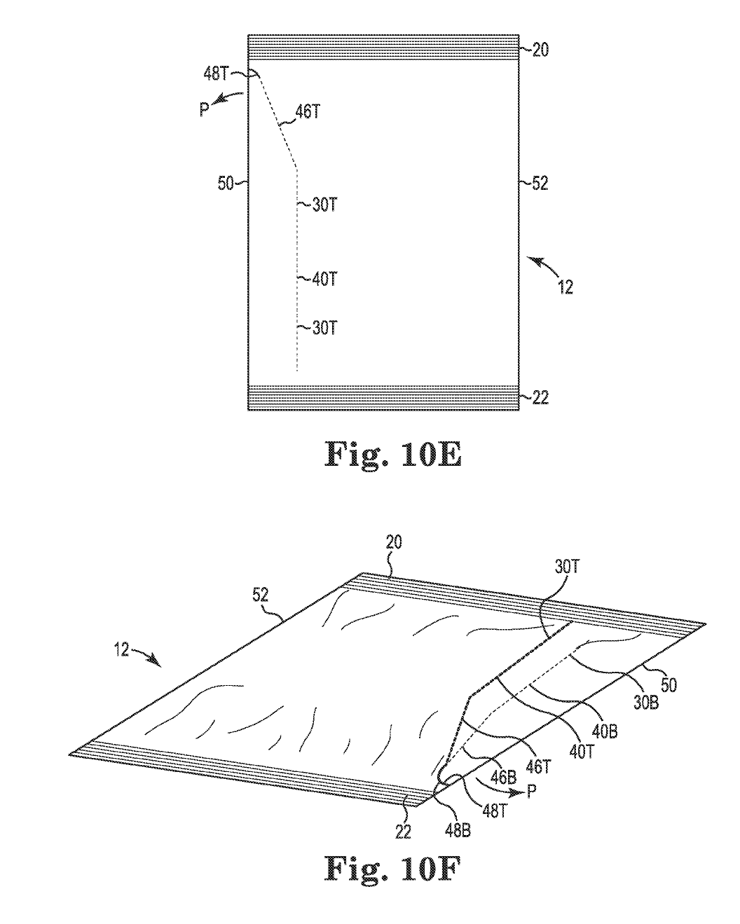

In the embodiment shown at FIG. 1, cutline 30 includes two segments 34 that extend along a length of package 12 in the “machine” direction, on generally opposite sides of package 12; another segment, 36, extends along a width of package 12 to connect length-wise segments 34. In alternate embodiments, a cutline may be located to extend across a surface of a pouch in other patters, e.g., diagonally, meaning that the cutline has directional components in both the width direction and the length direction. Specific examples are shown at FIGS. 10A, 10B, 10C, 10D, 10E, and 10F.

FIG. 10A shows package 12, which includes cutline 30 (shown as a dashed line). Package 12 has a length and width as illustrated at FIG. 1. Cutline 30 includes partial-cut portions 32 and full-cut portions (vent holes) 28 (see figures 11A, 11B, and 11C). Cutline 30 includes five segments: segments 40, 42, 44, 46, and 48. Segments 40 and 42 extend in the length direction, along sides of pouch 12. Diagonal segments 44 and 46 extend diagonally (in a direction that extends along both the length and the width of pouch 12) from the sides toward a center location of end seam 20. Tab 48 is at an intersection of diagonal segments 44. To open pouch 12 along cutline 30, tab 48 can be lifted and pulled in the direction of arrow P, away from endseam 20 and toward endseam 22.

Referring to FIG. 10B, cutline 30 includes four segments. Segments 40 and 42 extend in the length direction along sides of pouch 12. Diagonal segment 46 extends diagonally from one side to the opposite side, and toward a side location of end seam 20. Tab 48 is at an intersection of side segment 40 and diagonal segments 46. To open pouch 12 along cutline 30, tab 48 can be lifted and pulled in the direction of arrow P. away from endseam 20 and toward endseam 22.

Referring to FIG. 10C, cutlines 30A and 305 of pouch 12 includes multiple segments that define two openable segments. Cutline 30A includes segment 40A extending along a length of one side of package 12, segment 42A extending along a length of the opposing side of package 12 (in a crooked line that includes a straight segment and a diagonal segment), and shared diagonal segment 45 extending diagonally between central ends of segments 40A and 42A. Tab 48A is at an intersection of side segment 42A and shared diagonal segment 45. To open pouch 12 along cutline 30A, tab 48A can be lifted and pulled in the direction of arrow PA, away from endseam 22 and toward endseam 20. Cutline 30B is complementary to cutline 30A, and shares a common segment, shared diagonal segment 45. Cutline 30B includes segment 40B extending along a length of one side of package 12 (in a crooked line that includes a straight segment and a diagonal segment), segment 42B extending along a length of the opposing side of package 12, and shared diagonal segment 45 extending diagonally between central ends of segments 40B and 42B. Tab 48B is at an intersection of side segment 42B and shared diagonal segment 45. To open pouch 12 along cutline 30B, tab 48B can be pulled in the direction of arrow P, away from endseam 20 and toward endseam 22.

Package 12 of FIG. 10D is similar to package 12 of FIG. 10B except that segments 40 and 42 have reduced lengths.

FIGS. 10E and 10F show a topview and a side-perspective view of another embodiment of a package 12 having a cutline 30. In this embodiment, the cutline extends across both a top surface and a bottom side of the package, allowing the package to be opened at a side of the package. Referring to the top view of FIG. 10E, cutlines 30T includes segment 40T extending lengthwise along a length of package 12, and diagonal segment 46T extending from a central end the end away from endseam 22) of segment 40T to a side of package 12 and near endseam 20. A similar but opposite cutline 30B can be located on the opposite (bottom) surface of package 12, as shown at FIG. 10F. Tabs 48T and 48B are located at side 50 of package 12 at an intersection of segments 46T and 46B. Package 12 can be opened by pulling tabs 48T and 48B in a direction away from package 12, as shown by arrow P, to open package 12 at side 50.

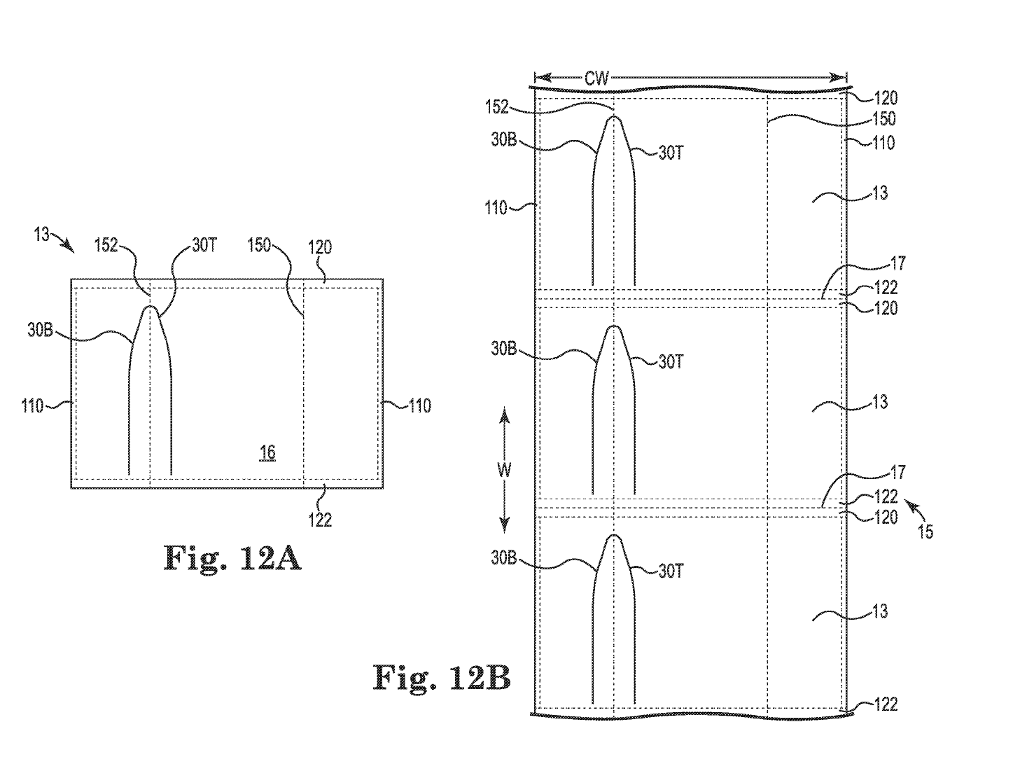

FIG. 12A shows an unfolded package material 13, which can be folded to produce a package 12 of FIG. 10E and 10F. Material 13 is a heat stable film 16 as described, optionally including printed graphics (not shown), and including cutline 30 (30T and 30B) as described herein. Material 13 can be folded along lines 150 and 152 to produce sides 50 and 52 (see FIG. 10E), so that opposing edges 110 are brought into contact to produce a (lengthwise) seam at a bottom (not shown) of package 12 of FIGS. 10E and 10F. Edge 120 folds onto itself to produce endseam 20, and edge 122 folds onto itself to produce endseam 22.

FIG. 12B, discussed in more detail below, shows a series of multiple materials 13 connected to form a web 15. Upon cutting web 15 at each of two separation lines 17, three separate materials 13 are formed, each of which can be used to produce a package 12 as shown at FIGS. 10E and 10F.

As shown in FIG. 1B, which is a cross-sectional view of pouch 12 taken along line B-B, film 16 defines cavity 26, which holds one or more precooked frozen dough or batter-based food products 14. In FIG. 1B, the dough or batter-based food products 14 depicted are pancakes, although fruit filled Danish, waffles, French toast, scones, breadsticks, donut, muffins, cinnamon rolls, pizza rolls, and the like may also be contained within the cavity. Other examples of useful food products that may be incorporated into a packaged food product, using a package as described, can include pre-cooked food products that have a topping or a filling, such as a Quesadilla, Pizza, Flatbread, Monkey bread, Bagel pulls, Grilled cheese sandwich, Breakfast sandwich, and the like.

As shown in FIG. 1, film 16 includes cutline, 30, which including an alternating series of full cuts (also referred to herein as vent holes) and partial cuts (also referred to herein as scoring) 32. The full cuts function as vent holes 28 that allow venting from the interior of the package, through the vent holes, to an exterior of the package, e.g., to allow steam and air to escape from the cavity 26 of pouch 12 when the pouch is exposed to heat. In the embodiment of FIG. 1, the vent holes 28 can be in any form, such as elongate or circular apertures arranged regularly, intermittently, or along intermittent patterns, over a length of cutline 30 (see FIGS. 11A, 11B, and 11C). Alternate vent hole configurations include, for example, laser perforations (circular apertures) resulting in a non-linear vent. Partial cuts (scoring) 32 of cutline 30 provide a line of weakness that allows film 16 to be fractured, torn, ripped, or otherwise separated along the length of cutline 30, into two pieces of film 16.

FIG. 11A illustrates an example of a cutline in detail, including partial-cut portions and full cut portions. As illustrated, film 16 (a heat stable, ovenable film as described) includes a top (e.g., exterior) surface 60, a lower (e.g., interior) surface 62, thickness (t). and may include a single layer or multiple layers (e.g., laminated layers), optionally including printing or graphics and a tie-layer located between the two layers. Cutline 30 extends along surface 60. Portions 28 of cutline 30 are full-cuts or apertures that penetrate the entire thickness (t) of film 16. Portions 32 of cutline 30 are partial cuts (which do not constitute apertures) that penetrate only a portion of the thickness (t) of film 16, e.g., a depth from surface 60 that extends to 25 percent of thickness t, e.g., 50 percent of thickness t, or even 75 percent of thickness t.

FIGS. 11B and 11C show details of additional embodiments of cutline 30. Cutline 30 is continuous over a surface of film 16, and is illustrated to be straight, but could be curved, cornered, or straight, or any combination curved, linear, and straight. FIG. 11B shows cutline 30, having partial-cut portions 32 connecting linear full-cut portions 28. Cutline 30 includes longer lengths of partial-cut portions 32 extending partially through the thickness of film 16, that allow opening along cutline 30, interrupted by shorter lengths of elongate or linear full-cut portions (apertures) 28, for venting, extending through the full thickness of film 16. FIG. 11C shows cutline 30, having partial-cut portions 32 connecting circular full-cut portions 28. Cutline 30 includes longer lengths of partial-cut portions 32 extending partially through the thickness of film 16, that allow opening along cutline 30, interrupted by shorter lengths of a series of closely-spaced round full-cut portions (apertures) 28, for venting, extending through the full thickness of film 16.

Any heat stable film capable of being formed into at least a portion of a package may be used in the present method and many such films, also known as “heatable” or “cook-in” films, are known. Typically, such films are comprised of one or multiple layers of polymeric materials, including, for example, polyesters such as polyethylene terephthalate, nylon, and the like. A useful film may include a single layer of polymeric material, or multiple layers of the same or different polymeric materials, optionally different polymeric materials that provide multiple functions. Examples of layers and functions that be part of a film or a film layer (e.g., co-extruded or laminated layers) include, e.g.: a barrier material layer such as an oxygen barrier layer, a carbon dioxide barrier layer, a moisture barrier layer, or one or more layers that perform a combination of these barrier properties; a layer that contains coated or embedded graphics; a layer that contains a chemical scavenger such as a carbon dioxide or an oxygen scavenger; an adhesive layer such as a thermoplastic adhesive layer; or combinations of these and other layers of materials that may be useful. Commercially available examples of such films include those sold under the trade designation Mylar (E.I. du Pont de Nemours, Wilmington Del.), Nylon 6 and Nylon 66 (E.I. du Pont de Nemours, Wilmington Del.), and Milprint Ovenable Film (Milprint, Oshkosh Wis.),

According to certain embodiments of films and methods, a cutline can he produced by laser-cutting methods, in these laser-cutting methods, a laser will produce partial-cut portions of a cutline. Certain heatable films can be particularly useful for forming a partial-cut portions of a cutline, including laminated multi-layer heatable films. In specific, a laminated multi-layer heatable film will have a boundary between the layers that is relatively clearly defined, as compared to a boundary between layers of a multi-layer film formed by another method, such as coextruding. A more clearly defined boundary between layers of a multi-layer beatable film will allow for improved formation of partial-cut portions using a laser. A typical laminated multi-layer heatable film will have a film layer, an adjacent layer of print (if this is a printed retail package), a tie layer adjacent to the layer of print (that holds the two layers together), and a second film layer (placing the layer of print and the tie layer between the two film layers. The two film layers may be made from any polymer material, such as PET (Polyethylene terephthalate), which can withstand sustained temperatures above 425 Fahrenheit without degradation, A PET/PET structure can be a preferred multi-layer laminated heatable film for methods and products described herein. Other useful multi-layer laminated heatable film structures include PET/Metalized multi-layer films, PET/Foil multi-layer films, and PET/Foil laminated multi-layer films. Layer thickness can depend upon on the application of the film and the power of a laser used to produce portions of the cutline.

A heatable film (and heatable pouch) includes two or more vent holes in the film, located along the cutline. During heating of the food product, the vent holes allow heat or steam to escape from the cavity of the pouch. The number, size, shape, and arrangement of the vent holes in the pouch are selected to provide desired food product properties including, for example, moisture content, food temperature, relative humidity, and amount of condensation in the pouch. In some embodiments, the pouch contains about 20 or fewer vent holes, for example, about 15 or fewer vent holes, or about 6 to 12 vent holes. Other vent hole amounts may also be useful. In some embodiments, the number, size, and arrangement of vent holes can be chosen to provide a product moisture content that ranges from about 10% to about 60% moisture, for example, when the food product is heated at about 325° F. (163° C.) to about 375° F. (191° C.) for a time period of about 7 to about 15 minutes.

In many embodiments, vent holes in a pouch (or as part of a film, heatable film, or other package or package material) provide a vent area ratio that ranges from about 0.00005 to about 0.1 (vent area/pouch (or film) area), or from about 0.00005 to about 0.01 (vent area/pouch (or film) area), or from about 0.00005 to about 0.001 (vent area/pouch (or film or package) area). Vent area ratio refers to a ratio of vent area to pouch (or film) area. Vent area refers to the combined open area of all vent holes in pouch (or package or film), e.g., measured in square meters. Pouch area refers to the surface area of a pouch (or package), e.g., measured in square meters. Film area refers to the surface area of a film (or other package material), e.g., measured in square meters.

Any desired shape may be used for a vent hole. For example, a vent hole may be circular or linear, rectangular, oval, square, diamond-shaped, etc. Multiple vent holes may be distributed on a pouch or film in any desired arrangement or pattern along a cutline. In some embodiments, vent holes can be positioned along an edge of a pouch or film in a linear arrangement. In other embodiments vent holes may be located at a more central surface of a pouch, package, or film, optionally in a linear or a curved arrangement.

A cutline, including partial-cut portions (scoring) and full-cut portions (vent holes) may be formed by any useful process for creating cuts, scoring, vent holes, etc., with controlled sizes in a heatable film, package, or package material. Examples include mechanical cutting devices such as a blade or rotary dies, laser cutting and perforation devices, and combinations of mechanical and laser devices. A cutline can be formed manually or by automated, high speed processing. All feature of a cutline can be formed by a single device, or, alternately, different features of a the same cutline can be formed using different devices. For example, a partial-cut portion of a cutline may be formed using one laser, and a full-cut portion of the same cutline may be formed using a second laser. Alternately a partial-cut portion may be formed using a laser, and a full-cut portion may be formed in the same cutline using a mechanical blade or die. A cutline may be formed on a package material either before or after the package material is formed into a pouch or other package.

One exemplary methods of forming a cutline in a packaging material can be, by use of high speed processing equipment, forming cutlines on a large web of packaging material film that can then be converted (e.g., cut, folded, etc.) to individual packages. These methods can involve high speed movement of a web along a device that can produce a cutline as described herein, using high speed cutting and registration techniques. These techniques can allow for cutting full-cut portions and partial-cut portions, at high speed, in the direction of movement of the web (the web direction), in the direction perpendicular to the movement of the web (the cross-web direction), or diagonally along a length that has directional components in both the web direction and the cross-web direction. A web of packaging material can moved at high speed along this processing equipment, and one or more cutting device can produce partial-cut portions and full-cut portions in the moving film to produce a cutline as described and illustrated herein. Exemplary equipment and methods for this type of processing, including high speed movement of a film, cutting, and registration, are shown, e.g., in U.S. Pat. No. 7,640,836 (Ser. No. 09/615,812); United States Patent Application Publication 2011/0073576 (Ser. No. 12/892,335); and International Application Number PCT/US02/15938 (International Publication Number WO 02/092274), the entireties of each of these being incorporated herein by reference.

FIG. 12B, shows a web 15 that can be prepared or processed in the form of a moving web, using laser or die cutting equipment to produce a cutline (e.g., cutlines 30T and 30B). Web 15 moves in web direction (W), which may correspond to a length of a package 12 (see FIG. 1). Cutlines or a segment of a cutline (e.g., 30) can be formed along the web direction, only. Alternately, a cutline or a segment of a cutline may be formed in a perpendicular (crossweb, CW) direction, or diagonally. These methods of producing multiple cutlines 30 along a moving piece of packaging material will produce a web that includes a series of multiple materials 13. Upon cutting web 15 at each of two separation lines 17, three separate materials 13 (see FIG. 12A) are formed, each of which can be used to produce a package 12 as shown at FIGS. 10E and 10F.

FIGS. 12A and 12B illustrate packaging materials and webs that include cutline 30 shown at FIGS. 10E and 10F; alternately, a package material 13 or web 15 could include a cutline of any other configuration that is described or illustrated herein, such as a cutline as illustrated at any of FIGS. 10A, 10B, 10C, and 10G.

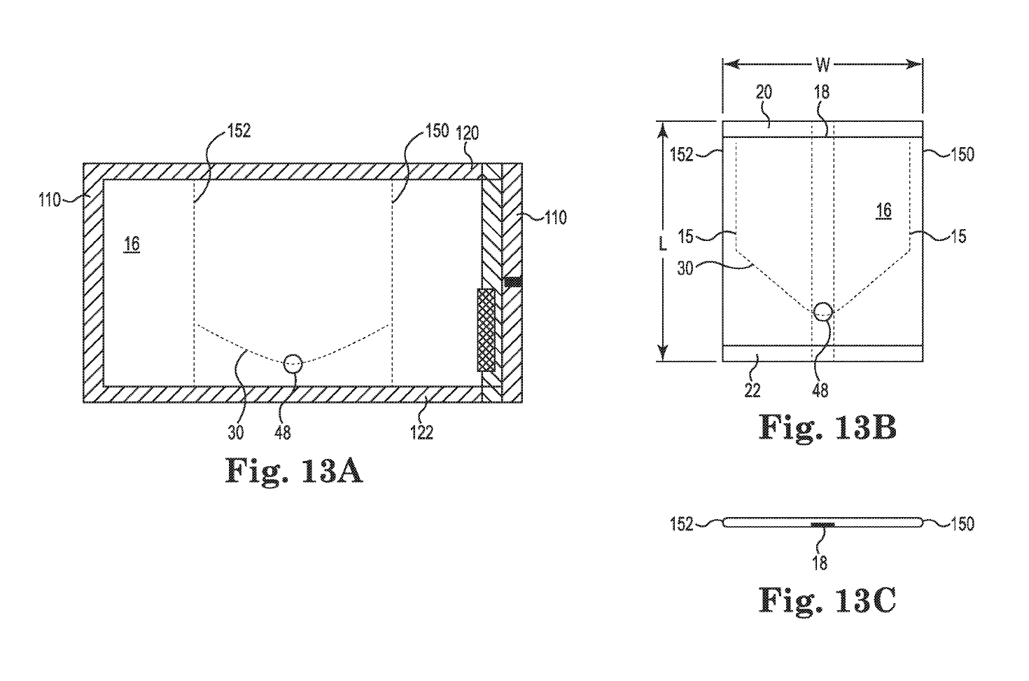

FIGS. 13A and 13B illustrate alternate configurations of package material 16 and package 12, each of which includes cutline 30 shown at FIGS. 10E and 10F; alternately, a package material 16 could include a cutline of any other configuration that is described or illustrated herein, such as a cutline as illustrated at any of FIGS. 10A, 10B, 10C, and 10D. FIG. 13A shows unfolded package material 16, which can be folded to produce a package 12 of FIG. 13B. Material 16 is a heat stable film as described, optionally including printed graphics (not shown), and including cutline 30 as described herein. Material 16 can be folded along lines 150 and 152 to produce sides 150 and 152 (see FIG. 10E), so that opposing edges 110 are brought into contact to produce lengthwise seam 18 at a bottom (not shown) of package 12. Edge 120 folds onto itself to produce endseam 20, and edge 122 folds onto itself to produce endseam 22.

FIGS. 13B (top view) and 13C (end view) show pouch 12 prepared from material 16, with cutline 30 extending along a curved path across package 12 in a cross web (width) direction. Tab 48 (which as illustrated is a piece of material secured to but not part of material 16) is located at an apex of the curve of cutline 30, and can be pulled away from package 12 to open pouch 12 along cutline 30. After being opened along the length of cutline 30, the flap of package material 16 that is thereby produced can be pulled toward end 20, still using tab 48, and can cause package material 16 to easily and predictably tear in the machine or web direction of material 16 along dashed lines 15 (which are not cutlines).

According to embodiments of the invention, the ratio of the total area of vents in a package, to the total area of the package, can be selected to produce desired venting of a package upon heating, and holding. A vent area ratio can relate to an area of vents compared to an area of a package, such as package 12; alternately to an area of vents compared to an area of a package material, such as package material 13 shown at FIG. 12A; and also, alternately, an area of vents compared to an area of a web, such as web 15 shown at FIG. 12A. That is, a package material 13 can have a vent area ratio in a range from about 0.00005 to about 0.1 (vent area/area of package material 13) or as otherwise functionally or specifically described herein, and a web 15, made up of multiple package materials 13, can have an identical or similar vent area ratio a range From about 0.00005 to about 0.1 (vent area/area of web 15) or as otherwise functionally or specifically described herein.

Preferred vent area ratios may be selected to provide a desired crust moisture content in the heated food product. For example, a vent area ratio may be selected to provide a crust moisture content in a range from about 15% to about 45% in a heated food product. A desired moisture content depends on the type of frozen precooked dough or batter-based food product that is being heated. For example, a vent area ratio may be selected to provide a crust moisture of about 10% to about 20% for donuts, or about 35% to about 45% for pancakes.

Precooked dough or batter-based food products suitable for use in the present invention include, for example, pancakes, fruit filled Danish, scones, donuts, pizza rolls, breadsticks, muffins, waffles, French toast, and cinnamon rolls. In many embodiments the precooked dough or batter-based food products are miniature in size. and the pouch contains 1 or more, typically about 4 to about 10 of the dough or batter-based food products in each pouch. For example, in some embodiments, the pancakes or waffles range in diameter from about 1 inch to about 3.5 inches (2.54 cm to 8.89 cm). The French toast may be in the form of slices (i.e., approximately square) or sticks (i.e., rectangular). In some embodiments, the French toast is in the form of sticks have a size of about 0.5 inch by about 3 inches (1.27 cm to 7.62 cm). In some embodiments the food product is a fruit filled Danish, for example having a volume ranging from about 8 in³ to about 15 in³ (131 cm³ to 245 cm³). In some embodiments, the food product is a miniature muffin, for example, having a volume ranging from about 2 in³ to about 4 in³ (32.8 cm³ to 65.5 cm³). The recipe used to prepare the dough or batter-based food product includes any recipe that can be used to prepare a food product suitable for being cooked and frozen in a cooked state for later reheating.

After being initially cooked (i.e., precooked), one or more of the dough or batter-based food products can be inserted into a pouch and sealed for storage. The pouch is typically hot-sealed, for example, by using metal sealing jaws at a temperature of about 245° F. (118° C.) for a dwell time of about 2.5 seconds. The sealed pouch containing the dough or batter-based food products is then frozen, for example, at a temperature ranging from about −10° F. (−23.3° C.) to about 0° F. (−17.7° C.). The frozen dough or batter-based food product can then be stored for an extended period (e.g., about 12 to about 36 weeks) prior to being heated for consumption.

Heating of the frozen precooked dough or batter-based food product is typically conducted in a convection oven although a microwave or conventional oven may also be used. Heating temperatures typically range from about 325° F. (163° C.) to about 375° F. (191° C.) for times ranging from about 7 to about 15 minutes. The reheating temperature and time may vary for example, depending upon the type of oven, number of food products being reheated, whether the product is frozen or thawed, and the like. Heating is conducted in order to achieve a temperature suitable for serving the food product to a consumer. For example, the heated product may be at a temperature ranging from about 120° F. (48.9° C.) to about 180° F. (82.2° C.), although other temperatures may be suitable. After heating, the food product may be held at desired temperature in the pouch for a desired period of time, for example, to accommodate cafeteria-style serving or food service holding of the food product. For example, the heated dough or batter-based food product may be held for a time period ranging from about 10 minutes to about 240 minutes at a temperature ranging from about 130° F. (544° C.) to about 155° F. (65.6° C.). For a user to consume the heated, packaged food product, a package as described herein, comprising a cutline, can be opened by pulling on the package to create an opening along the cutline.

The invention will now be described with reference to the following non-limiting examples.

### EXAMPLES

The following Examples show packages that include vent holes as described herein, but that are not described to not include partial cutting or scoring to connect the vent holes, to produce a cutline as described herein.

This example was conducted in order to determine if a relationship existed between the pancake crust moisture content and the vent area in the pouch. Samples having a range of vent area ratios were tested. Vent area ratios ranging from 0 to 0.125 m² were tested and crust moisture was measured for each vent structure. For the testing, crust moisture content was measured using a CEM brand microwave moisture analyzer. The CEM analyzer uses a balance and microwave energy to heat the sample, without burning, until all the moisture has evaporated. The frozen dough based food product was heated to the desired temperature in vented packaging in a convection oven. The food product was then removed from the pouch and a 1 to 3 gram sample of the crust was taken from the heated food product. The sample was deposited onto the sample balance of the CEM moisture analyzer and the crust moisture was measured. The CEM settings used were as follows.

### CEM Settings

| Description | Setting | |
|---|---|---|
| Power | 50% | |
| Change Wt. | 0.4 | mg |
| Time max | 15 | minutes |
| Temp max | 80° C. (176° F.) | |
| Wt minimum | 1 | gram |
| Wt maximum | 3 | grams |

| | |
|---|---|
| Comp | On |

The settings cause the CEM machine to use 50% of the microwave power, and to measure the sample weight until it has stabilized to within 0.0004 grams over a time period of 10 seconds. The maximum time of the test was limited to 15 minutes, and the maximum allowed temperature of the food product was 80° ((176″ F.). In some instances, the maximum temperature Setting On the CEM moisture analyzer was adjusted for a particular food product. For example, pancakes required a maximum temperature setting of 90° C. (194° F.), and breadsticks required a maximum temperature setting of 70° C. (158° C.) to prevent burning.

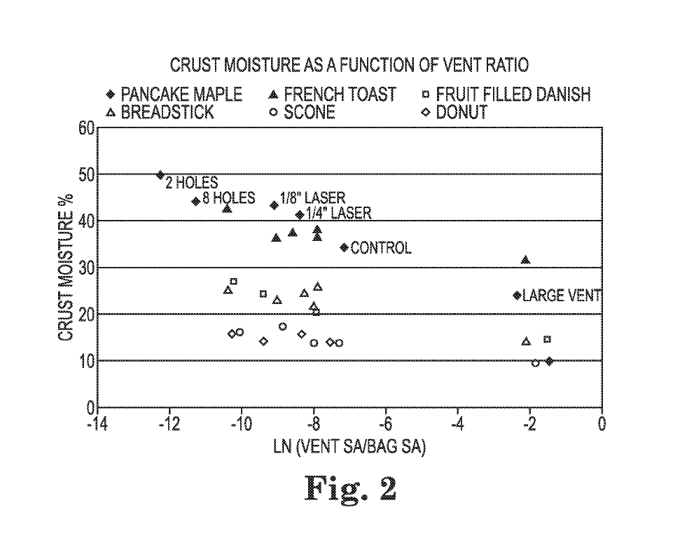

Initially, when crust moisture was plotted as a function of vent area the graph indicated an exponential relationship. The natural log (i.e., Ln) of the vent ratio was calculated and is plotted in FIG. 2. FIG. 2 shows the relationship between crust moisture content and vent area for various food products. FIG. 2 demonstrates that increasing the vent area allows more moisture to escape and thus results in a lower crust moisture. The data graphed in FIG. 2 is also provided in TABLES 1-6.

TABLE 1
Mini Maple Pancakes

| Vent ratio | % moist | Ln (vent ratio) |
|---|---|---|
| 0 | 49.86 | |
| 0.000004854 | 49.68 | −12.2357 |
| 0.000012816 | 44.34 | −11.2648 |
| 0.000116329 | 43.49 | −9.05909 |
| 0.000231288 | 41.54 | −8.37185 |
| 0.000794702 | 34.4 | −7.13754 |
| 0.098455598 | 24.19 | −2.31815 |

TABLE 2
Fruit Filled Danish

| Vent ratio | % moist | Ln (vent ratio) |
|---|---|---|
| 0 | 32.16 | |
| 0.000035389 | 27.17 | −10.249085 |
| 0.000081192 | 24.45 | −9.4186951 |
| 0.000330042 | 20.49 | −8.0162919 |
| 0.000342570 | 19.96 | −7.9790355 |
| 0.000367477 | 20.42 | −7.9088502 |
| 0.224803978 | 14.54 | −1.4925265 |

TABLE 3
French Toast

| Vent ratio | % moist | Ln (vent ratio) |
|---|---|---|
| 3.04599E−05 | 42.88 | −10.399098 |
| 0.000117062 | 36.49 | −9.052809 |
| 0.000189289 | 37.61 | −8.572238 |
| 0.000374466 | 38.15 | −7.8900107 |
| 0.000381000 | 37.03 | −7.8727112 |
| 0.127350967 | 31.61 | −2.0608085 |

TABLE 4
Breadsticks

| Vent ratio | % moist | Ln (vent ratio) |
|---|---|---|
| 3.0426E−05 | 25.39 | −10.400214 |
| 0.000118262 | 23.07 | −9.0426118 |
| 0.000250864 | 24.55 | −8.2905988 |
| 0.000327252 | 21.86 | −8.0247797 |
| 0.000369258 | 26.06 | −7.904016 |
| 0.123685838 | 14.25 | −2.0900105 |

TABLE 5
Scones

| Vent ratio | % moist | Ln (vent ratio) |
|---|---|---|
| 4.09528E−05 | 16.14 | −10.103089 |
| 0.000136258 | 17.43 | −8.9009579 |
| 0.000322478 | 13.84 | −8.0394748 |
| 0.000648787 | 13.81 | −7.3404065 |
| 0.158851351 | 9.55 | −1.8397864 |

TABLE 6
Donuts

| Vent ratio | % moist | Ln (vent ratio) |
|---|---|---|
| 3.367E−05 | 15.86 | −10.298902 |
| 0.000079745 | 14.26 | −9.4366788 |
| 0.000232006 | 15.79 | −8.368748 |
| 0.000515788 | 13.96 | −7.5698139 |
| 0.235939508 | 9.86 | −1.4441798 |

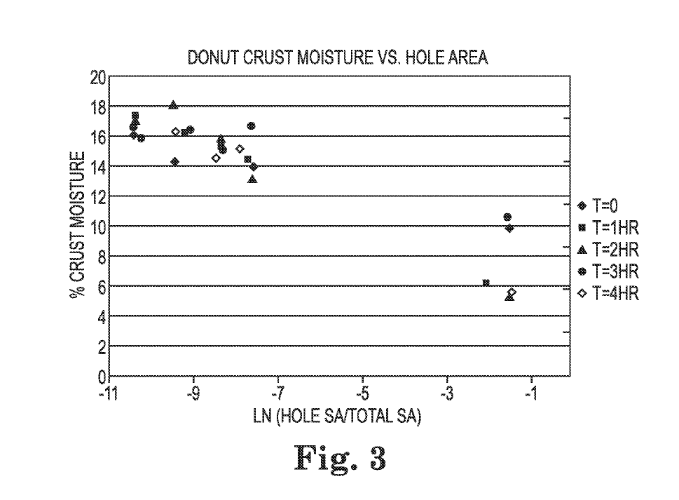

It was also shown that the crust moisture content was maintained over time when product was stored in a warmer. FIG. 3 shows that the crust moisture content given a vent ratio is maintained over the holding time. Frozen dough-based products (i.e., donuts) were heated in a convection oven and were then held in a warming cabinet for 4 hours at 150 F (65.5° C.). The graph shows that the crust moisture content in relation to the specific vent ratio is maintained for four hours of holding time in a warming cabinet.

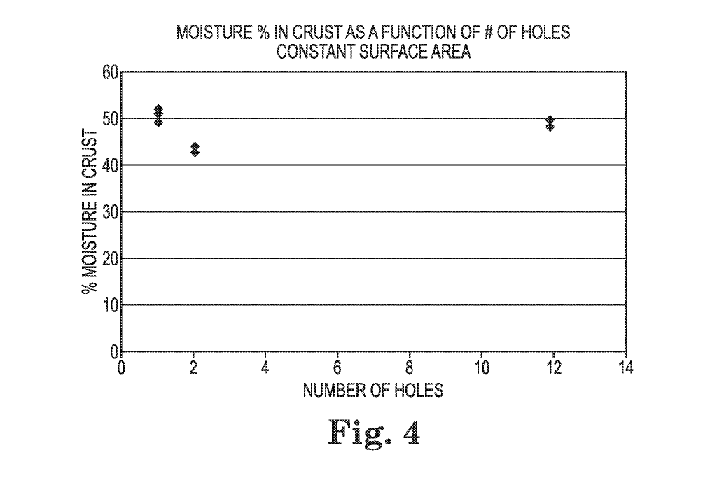

It was also shown that at a constant vent area ratio, the change in crust moisture percent as a function of the number of vent holes is negligible. Packages were tested at a constant vent area ratio while varying the number of vents used to attain the vent area ratio. The results show that crust moisture is affected by the vent area ratio, not the number of vents in the pouch. The results are presented in TABLE 8 and in FIG. 4.

TABLE 8
Data from pancakes at constant vent area

| Vent ratio | % moist | Ln (vent ratio) | # holes |
|---|---|---|---|
| 0.000849773 | 51.86 | −7.07054 | 1 |
| 0.000849773 | 51.08 | −7.07054 | 1 |
| 0.000849773 | 49 | −7.07054 | 1 |
| 0.000864500 | 44.38 | −7.05336 | 2 |
| 0.000864500 | 44.79 | −7.05336 | 2 |
| 0.000864500 | 43.14 | −7.05336 | 2 |
| 0.000800320 | 49.66 | −7.1305 | 12 |
| 0.000800320 | 48.51 | −7.1305 | 12 |
| 0.000800320 | 48.2 | −7.1305 | 12 |

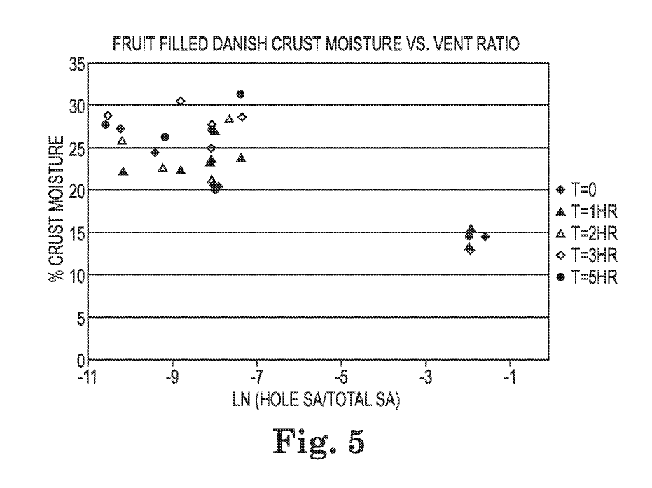

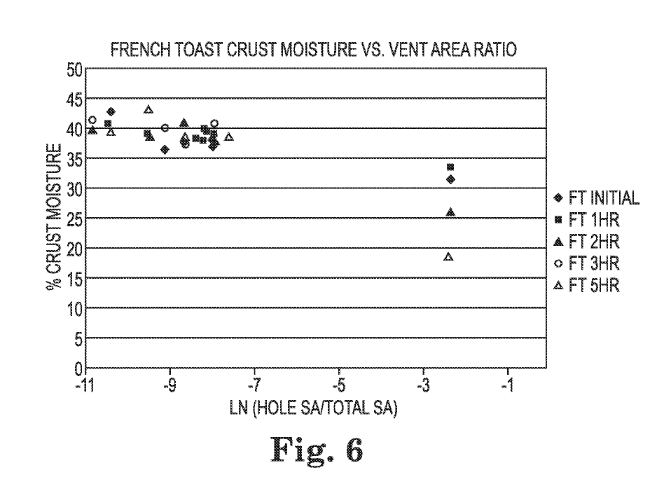

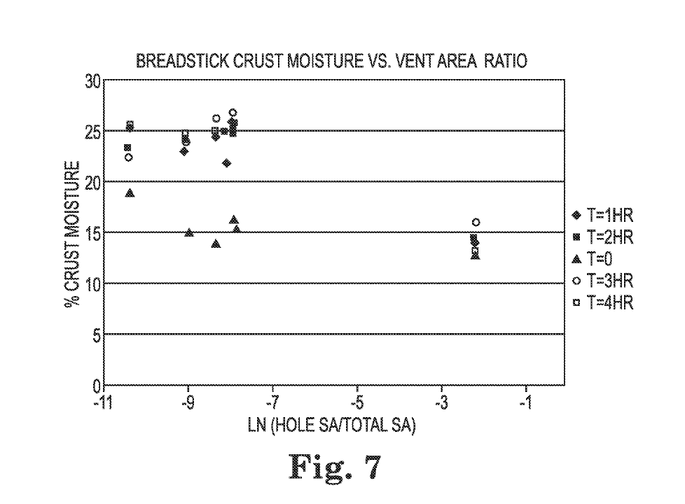

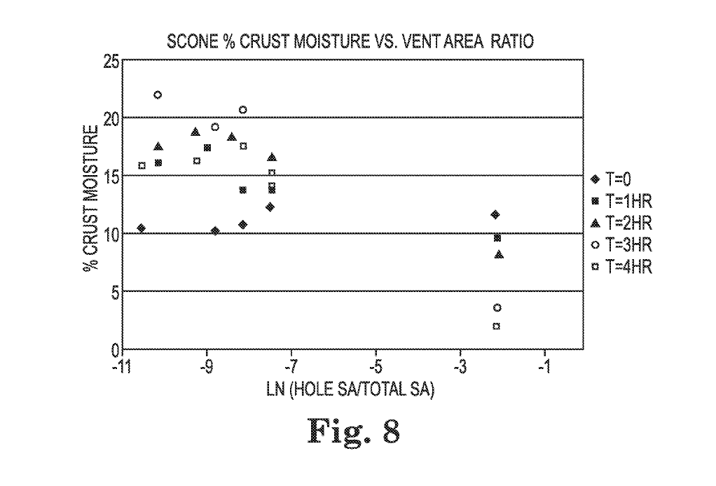

TABLES 9-11 and FIGS. 5-8 provide additional data on various embodiments of the invention that were tested.

TABLE 9
Mini Muffins Crust Moisture

| Vent ratio | % moist | Ln (vent ratio) | Product Type |
|---|---|---|---|
| 0.087837838 | 6.93 | −2.43226 | Blueberry muffin |
| 0.000533547 | 13.56 | −7.53596 | Blueberry muffin |
| 0.000018773 | 25.45 | −10.8831 | Blueberry muffin |
| 0.029166000 | 14.05 | −3.53496 | Apple cinnamon |
| 0.000823121 | 17.25 | −7.10241 | Apple cinnamon |
| 0.000811688 | 20.95 | −7.11639 | Apple cinnamon |
| 0.000235895 | 21.98 | −8.35212 | Apple cinnamon |
| 0.000117148 | 25.81 | −9.05207 | Apple cinnamon |
| 0.000013246 | 25.9 | −11.2318 | Apple cinnamon |

TABLE 10
Mini Waffles Crust Moisture

| Vent ratio | % moist | Ln (vent ratio) | Type |
|---|---|---|---|
| 0.124551724 | 30.61 | −2.08303 | waffle |
| 0.120599366 | 21.42 | −2.11528 | waffle |
| 0.000225788 | 42.5 | −8.39591 | waffle |
| 0.000225788 | 40.92 | −8.39591 | waffle |
| 0.000111477 | 46.42 | −9.10169 | waffle |
| 0.000115182 | 43.67 | −9.06899 | waffle |
| 0.000042953 | 37.84 | −10.0554 | waffle |
| 0.000022063 | 39.19 | −10.7216 | waffle |
| 0.000006573 | 43.53 | −11.9326 | waffle |
| 0.000020294 | 41.06 | −10.8052 | waffle |

TABLE 11
French Toast Mini Sticks crust moisture

| Vent ratio | % moist | Ln (vent ratio) | Type |
|---|---|---|---|
| 0.102857143 | 32.91 | −2.27441 | French toast |
| 0.000222836 | 41.36 | −8.40907 | French toast |
| 0.000218551 | 37.43 | −8.42849 | French toast |
| 0.000121764 | 33.35 | −9.01342 | French toast |
| 7.3076E−05 | 42.63 | −9.52401 | French toast |
| 7.16161E−06 | 39.05 | −11.8468 | French toast |

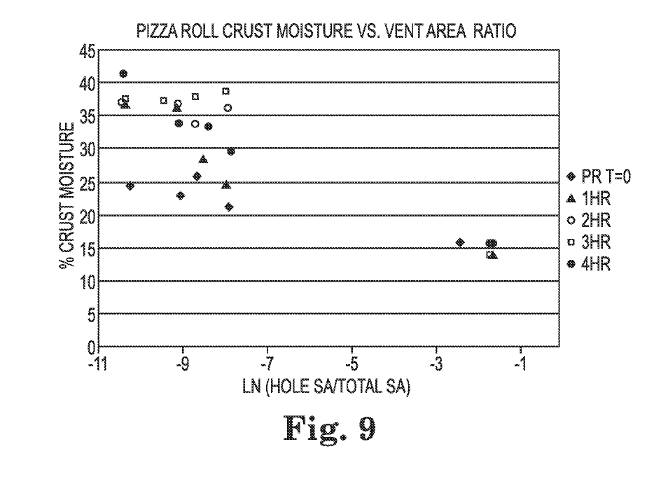

In some embodiments, the precooked frozen dough or batter-based food products have a very high water activity filling (e.g. pizza rolls) which causes a change in crust moisture content over hold time. Frozen Pizza rolls are an example where the water activity is greater than 0.95. The data in FIG. 9 demonstrate that, for pizza rolls, the crust moisture increases as warmer hold time increases.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

1. A packaged frozen precooked dough or batter-based food product comprising:
(a) one or more frozen precooked dough or batter-based food products; and
(b) a heatable pouch comprising heatable film having a thickness, the heatable pouch encasing the one or more frozen precooked dough or batter-based food products;
(c) a cutline in the heatable film, the cutline comprising
a length,
multiple partial-cut portions, each partial-cut portion comprising a cut that extends partially through the thickness of the heatable film, and
multiple vent hole portions, each vent hole portion comprising a vent hole that extends completely through the thickness of the heatable film.

2. The food product of claim 1, wherein the vent holes provide a vent area ratio ranging from about 0.00005 to about 0.1 (vent area/pouch area).

3. The food product of claim 1, wherein a portion of the package can be manually pulled away from another portion of the package to open the package along the cutline.

4. The food product of claim 1, wherein the package has a width and a length, and the cutline extends in a direction that includes a component in the width direction and a component in the length direction.

5. The food product of claim 1, wherein the cutline is located on an outer surface of the pouch.

6. The food product of claim 1, wherein the partial-cut portion has a depth of from 25 percent to 75 percent of a thickness of the heatable film.

7. The food product of claim 1, wherein the heatable film comprises multiple layers, at least one layer comprising polymer selected from the group consisting polyester and nylon.

8. The food product of claim 1, wherein the heatable pouch has a vent area ratio ranging from about 0.00005 to about 0.001 (vent area/pouch area).

9. A method of preparing a heated dough or batter-based food product from a frozen packaged dough or batter-based food product, the method comprising the steps of:
(a) providing a packaged precooked dough or batter-based food product according to any of claims 1 to 8, encasing one or more frozen precooked dough or batter-based food product; and
(b) heating the one or more frozen precooked dough or batter-based food product in the heatable pouch.

10. The method of claim 9, wherein the heated dough or batter-based food product has a moisture content ranging from about 10% to about 60%.

11. The method of claim 9 or 10, wherein the heating step comprises heating at a temperature of about 325° F. (163° C.) to about 375° F. (191° C.) for a time period ranging from about 7 to about 15 minutes.

12. The method of any of claims 9 to 11, comprising holding the heated dough or batter-based food product at a temperature ranging from about 120° F. (48.9° C.) to about 180° F. (82.2° C.) for a time period of about 30 to 240 minutes; wherein the heated dough or batter-based food product has a crust moisture content ranging from about 10% to about 60%.

13. The method of any of claims 9 to 12, comprising opening the heatable pouch by separating one portion of the package from another portion of the package, along the cutline.

14. A packaging material comprising
a heatable film having a width, a length, a thickness, a surface, and a surface area, the heatable film comprising a cutline at the surface, the cutline comprising
multiple partial-cut portions, each partial-cut portion comprising a cut that extends partially through the thickness of the heatable film, and
multiple vent hole portions, each vent hole portion comprising a vent hole that extends completely through the thickness of the heatable film.

15. The packaging material of claim 14 wherein the vent holes provide a vent area ratio ranging from about 0.00005 to about 0.1 (vent area/surface area).

16. The packaging material of claim 14 or 15 comprising multiple layers, at least one layer comprising polymer selected from the group consisting of polyester and nylon.

17. The packaging material of any of claims 14 to 16 wherein the partial cut extends through from 20 to 80 percent of a total thickness of the heatable film.

18. The packaging material of any of claims 14 to 17 comprising a laminated multi-layer film.

19. The packaging material of claim 18 comprising two polyethylene terephthalate layers.

20. The packaging material of any of claims 14 to 19, wherein the cutline extends in a direction that includes a component in a direction of the width, and a component in a direction of the length.

21. A method of preparing a heatable film having vent holes and partial cuts for easy opening, the method comprising:
providing a film having a width, a length, a thickness, a surface, and a surface area,
producing a cutline in the film, the cutline comprising
a length,
multiple partial-cut portions, each partial-cut portion comprising a cut that extends partially through the thickness of the heatable film, and
multiple vent hole portions, each vent hole portion comprising a vent hole that extends completely through the thickness of the heatable film.

22. The method of claim 19 wherein the vent holes provide a vent area ratio ranging from about 0.00005 to about 0.1 (vent area/surface area).

23. The method of claim 21 or 22 wherein the film has a width and a length, and the length of the cutline includes a component in the width direction and a component in the length direction.

24. The method of any of any of claims 21 to 23 wherein the cutline is produced using a laser, using a blade, or a using a combination of a laser and a blade.

25. The method material of any of claims 21 to 24 wherein the film comprises a laminated multi-layer film.

26. The method material of any of claims 21 to 25 wherein the film comprises two polyethylene terephthalate layers.
